(19) United States
(12) Patent Application Publication
(10) Pub. No.: US 2009/0042165 A1
(43) Pub. Date: Feb. 12, 2009

(54) Dental instrument

(76) Inventors: Tom Garrison, Spring Lake, MI (US); John E. Garrison, Spring Lake, MI (US); Robert Anderson, Coopersville, MI (US); Scott Doenges, West Olive, MI (US); Schuyler VanGorden, Eau Claire, WI (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 12/072,161

(22) Filed: Feb. 25, 2008

Related U.S. Application Data
(60) Provisional application No. 60/903,171, filed on Feb. 23, 2007.

(51) Int. Cl. A61C 3/08

(52) U.S. Cl. 433/164

(57) ABSTRACT

A dental instrument comprises a handle member and a tool assembly. The handle member includes a first end, a second end and a longitudinal axis. The tool assembly extends from the first end of the handle member. The tool assembly comprises a tool arm, a first blade member and a second blade member. The tool arm has a proximal end extending from the first end of the handle and a distal end spaced therefrom. The first blade member extends away from the distal end of the tool arm and has a first flattened region. The second blade member extends away from the distal end of the tool arm and has a second flattened region. The first and second flattened regions are substantially perpendicular to each other in one dimension. The first blade member is configured for substantially transverse movement within a mouth of a patient. The second blade member is configured for substantially longitudinal movement within a mouth of a patient. Rotation of the handle member about the longitudinal axis thereof alternatively places one of the first and second blade member in an operative position.

### CROSS REFERENCE TO RELATED APPLICATION

This application claims priority from U.S. Provisional Patent Application Ser. No. 60/903,171 filed Feb. 23, 2007 entitled “Dental Instrument,” the entire disclosure of which is incorporated herein by reference.

This application is also related to U.S. patent application Ser. No. 11/453,281 filed Jun. 14, 2006, entitled “Dental Instrument” which claims priority to U.S. Provisional Patent Application Ser. No. 60/690,424 filed Jun. 14, 2005, and entitled “Dental Instrument,” the entire disclosure of each of which is incorporated herein by reference.

### BACKGROUND OF THE INVENTION

1. Field of the Invention

The present invention relates in general to dental instruments, and more particularly to a dental instrument which includes a number of tools attached thereto, and blades positioned on one end thereof, wherein a practitioner can easily switch therebetween.

2. Background Art

Dental instruments for filling cavities, for example, have been known in the art. One example of such an instrument is shown in U.S. Pat. No. 4,643,677 issued to Kim. While this instrument has combined several dental tools, it nevertheless has drawbacks.

Among other drawbacks, certain of the instruments are difficult to manipulate in their current position and configuration. Second, certain instruments which are utilized in conjunction with the tools that are present in the tool must be separately utilized. The dental practitioner must often reach for other instruments. In the end, the dental practitioner is nevertheless faced with changing instruments within a restoration. Thus, while the instruments of the prior art increase efficiency, there is still a large gap inasmuch as the instrument set is quite incomplete.

Thus, it is an object of the present invention to improve the position and function of a dental instrument.

It is another object of the invention to provide additional instruments which form a set of commonly utilized tools for certain dental procedures.

It is another object of the invention to enhance the configuration of the instruments to lessen tool interference.

It is another object of the invention to provide an enhanced configuration to blades used in dental procedures.

These and other objects of the invention will become apparent in light of the specification and claims appended hereto.

### SUMMARY OF THE INVENTION

A dental instrument comprises a handle member and a tool assembly. The handle member includes a first end, a second end and a longitudinal axis. The tool assembly extends from the first end of the handle member. The tool assembly comprises a tool arm, a first blade member and a second blade member. The tool arm has a proximal end extending from the first end of the handle and a distal end spaced therefrom. The first blade member extends away from the distal end of the tool arm and has a first flattened region. The second blade member extends away from the distal end of the tool arm and has a second flattened region. The first and second flattened regions are substantially perpendicular to each other in one dimension. The first blade member is configured for substantially transverse movement within a mouth of a patient. The second blade member is configured for substantially longitudinal movement within a mouth of a patient. Rotation of the handle member about the longitudinal axis thereof alternatively places one of the first and second blade member in an operative position.

In a preferred embodiment, the first flattened region is substantially parallel to a plane defined by the longitudinal axis of the handle.

In another preferred embodiment, the first flattened region and the second flattened region are angled relative to each other at an angle between 85° and 125°.

In yet another preferred embodiment, the second end of the handle member includes a pair of plugger elements.

Preferably, the second end of the handle member includes at least one of a burnisher and a carver.

The invention further comprises a method of utilizing a dental instrument comprising the steps of: providing a dental instrument having a first blade member and a second blade member extending from a first end thereof; utilizing the first blade member; rotating the handle member along a longitudinal axis of the handle member a predetermined angular distance; and utilizing the second blade member.

In a preferred embodiment, the step of utilizing the first blade member further comprises the step of transversely moving the first blade member within the mouth of a patient. The step of utilizing the second blade member further comprises the step of longitudinally moving the second blade member within the mouth of a patient.

In another preferred embodiment, the dental instrument further comprises a second end having a plurality of plugger members. The method further comprising the step of rotating the tool so as to place the second end in an operative position within the mouth of the patient.

### BRIEF DESCRIPTION OF THE DRAWINGS

The invention will now be described with reference to the drawings wherein:

FIG. 1 of the drawings comprises a perspective view of the dental instrument of the present invention;

FIG. 2 of the drawings comprises a top plan view of the dental instrument of the present invention;

FIG. 3 of the drawings comprises a side elevational view of the dental instrument of the present invention;

FIG. 4 of the drawings comprises a partial perspective view of the dental instrument of the present invention, showing in particular the first tool assembly;

FIG. 5 of the drawings comprises a partial perspective view of the dental instrument of the present invention, showing in particular the second tool assembly;

FIG. 6 of the drawings comprises a side elevational view of the dental instrument of the present invention, showing in particular the second tool assembly; and

FIG. 7 of the drawings comprises a partial perspective view of the dental instrument of the present invention, showing in particular an alternate embodiment of the first tool assembly.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

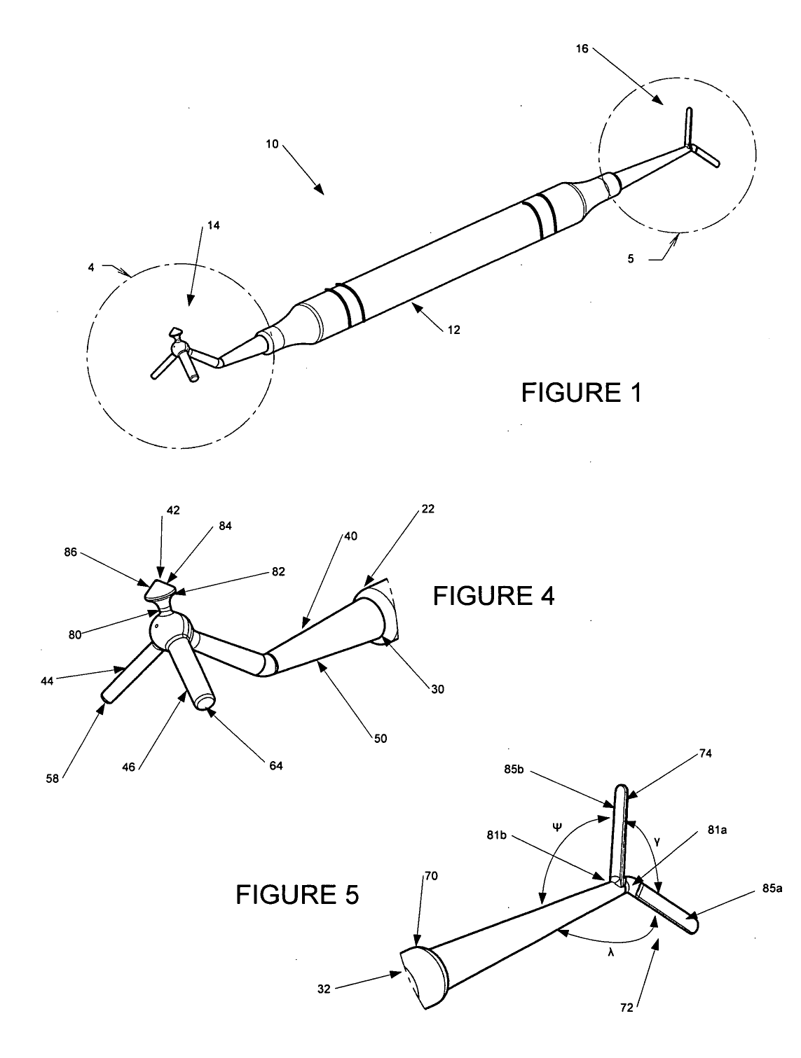

Referring now to the drawings and in particular to FIG. 1, the dental instrument of the present invention is shown generally at 10. The dental instrument includes handle member 12, first tool assembly 14, and second tool assembly 16. The first tool assembly is positioned at one end of the handle member and the second tool assembly is positioned at the other end of the handle member. The dental instrument is generally formed from a stainless steel member which is capable of withstanding the heat generated by autoclaving sterilization machines or dry-heat sterilization. It is contemplated that other materials may be utilized, certain of which materials are capable of surviving sterilization, and others which are more suited for disposable operation.

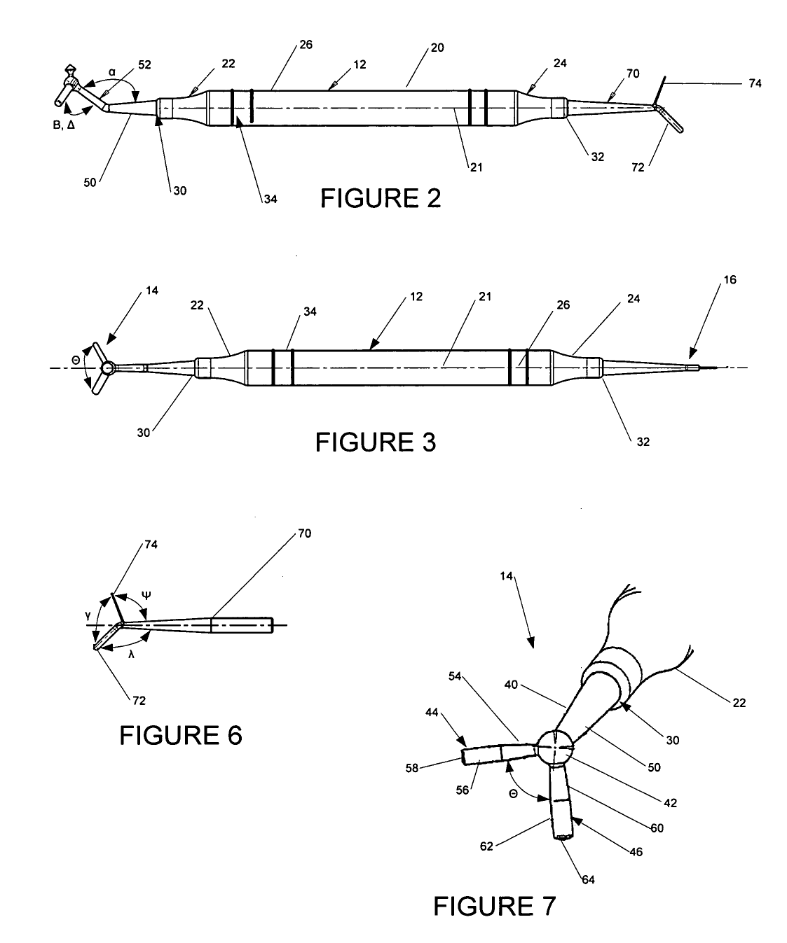

With reference to FIGS. 2 and 3, handle member 12 includes barrel 20, tapered first end 22, tapered second end 24 and means 26 for facilitating the gripping of the handle member by a user, such as a dental practitioner. The barrel is elongated and defines longitudinal axis 21. In the embodiment shown, the barrel has a substantially uniform circular cross-section, so as to define a narrow elongated cylinder. In other embodiments, the barrel may comprise a polygonal cross-section, such as, for example, a hexagonal or octagonal configuration. In yet other embodiments, the barrel may be a non-uniform configuration wherein the cross-section is of a varying configuration.

The tapered first end generally comprises an outwardly conical configuration which terminates with tool attachment region 30. In the present embodiment, the tapered configuration includes a curved outwardly conical configuration which terminates with a substantially flat tool attachment region. The tapered second end generally comprises a configuration which is much like that of the tapered first end, and terminates at tool attachment region 32. In the present embodiment, the configuration is substantially identical so that the user is able to become accustom to operating either end of the handle member. Of course, in other embodiments, it is contemplated that the tapered ends may be of different configurations—to accommodate the special needs of a particular desired utilization.

Gripping means 26 includes a plurality of serrations 34 which are positioned strategically along the barrel at points wherein a dental practitioner would grasp the barrel to utilize any one of the tools. In other embodiments, other gripping means are contemplated; such gripping means may comprise changes in surface configuration (and cross-section), coatings such as a rubberized coating or cover over portions of the barrel, etc.

First tool assembly 14 is shown in FIG. 1, and in greater detail in FIG. 4, as comprising first tool arm 40, acorn carver 42, first plugger element 44 and second plugger element 46. The first tool arm 40 includes first segment 50 and second segment 52 (FIG. 2). As is shown in FIG. 3, first segment 50 extends from tool attachment region 30 of tapered first end 22. The first segment extends generally along longitudinal axis 21, however it is contemplated that it may be disposed at an angle (α) (FIG. 3) relative to longitudinal axis 21. Second segment 52 extends from the end of first segment 50 and is disposed at an angle relative to first segment 50. The second segment is angled at approximately 145° relative to first segment 50. In other embodiments the first and second segments can be angled relative to each other at an angle of between approximately 125° and 175°. In the present embodiment, the second segment is shorter than the first segment, however, it is contemplated that the relative lengths of the various segments may be varied within the scope of the present invention.

Acorn carver 42 includes first region 80, second region 82, third region 84 and cap 86. The first region comprises an outwardly conical region which blends into a more aggressive, and generally non-uniform outwardly conical region which defines second region 82. The second region 82 blends into an inwardly outwardly conical region which defines third region 84. Finally, cap 86 comprises a substantially flattened region at the distal end of the acorn member. The radius of the flattened region is substantially smaller than any of the radial dimensions of the first region, second region or third region. It will be understood that a number of differently shaped acorn carvers, burnishers, and other tools may be positioned in place of acorn carver 42.

First plugger element 44 extends outwardly from the end of the second segment. The first plugger element is, in the embodiment of FIG. 4, a substantially cylindrical configuration which terminates with convex cap 58.

In the embodiment of FIG. 7, the first plugger element includes outwardly conical region 54, inwardly conical region 56 and convex cap 58. The outwardly conical region is outwardly conical and has a relative length of approximately 30% to 60% of the overall length of the first plugger element. The inwardly conical region is substantially uniformly inwardly conical (although variations are contemplated), and comprises between 40% and 70% of the total length of the first plugger element. Typically, the inwardly conical region may taper at, for example, 0.5° to 8°, and may be different or the same as the taper of the outwardly conical region. The convex cap precludes presence of flat surfaces at the end of the first plugger element. In certain embodiments, although less advantageous, the convex cap may be replaced with a substantially flat cap. Preferably, the first plugger element is shorter than second segment 52 in length.

The overall construction of the first plugger element in the embodiment of FIG. 7, facilitates the proper application of filler material with the convex cap, proper contact with the filler material with the inwardly conical region, while permitting the movement of the device and the unobtrusiveness of the device with the outwardly conical region proximate the burnisher.

Second plugger 46 in the embodiment of FIG. 4 includes a substantially uniform cylindrical member which terminates with convex cap 64. The second plugger has a larger diameter than the first plugger, while being substantially similar in length. In the embodiment of FIG. 7, the second plugger 46 includes outwardly conical region 60, inwardly conical region 62 and convex cap 64. The relative configuration of the second plugger is substantially identical to that of the first plugger of the embodiment of FIG. 7, however the second plugger has a larger radial dimension in each of the outwardly conical regions and the inwardly conical regions. Thus, the second plugger is well suited for larger dental cavities, whereas the first plugger is well suited for smaller dental cavities.

The first plugger and second segment 52 of the first tool arm 40 define a plane. Within this plane, the first plugger and the second segment are angled at a range of angles (β) (FIG. 2) between 65° and 115°, most preferably, approximately 90° relative to each other. Similarly, the second plugger and second segment 52 of the first tool arm 40 define a plane. Within this plane, the second plugger and the second segment are angled at a range of angles (Δ) (FIG. 2) between 65° and 115°, and most preferably, approximately 90°. Finally, the two plugger elements 44, 46 define a third plane. Within this plane, the first plugger element and the second plugger element are angled relative to each other at a range of angles (θ) (FIG. 3) between 65° and 125°, and most preferably, approximately 90°. Inasmuch as the separation between the above-described structures in any one of the three planes is approximately 90° the third plane is substantially orthogonal relative to the other two planes.

Second tool assembly is shown in FIG. 1, and in more detail in FIGS. 5 and 6, as comprising second tool arm 70, first blade member 72 and second blade member 74. The second tool arm 70 extends from tool attachment region 32 of tapered second end 24 (FIG. 3).

The blade members 72, 74 each extend from the distal extend of the second tool arm 70. The first blade member includes tapering region 81a and flattened region 85a. The second blade member includes tapering region 81b and flattened region 85b. The blade members are angled relative to each other at an angle (γ) which ranges between 85° and 125°, and most preferably at an angle of approximately 114°. The first blade member 72 is angled relative to the longitudinal axis of the handle at an angle (λ) which is between 85° and 155°, and most preferably approximately 135°. The second blade member 74 is angled relative to the longitudinal axis of the handle at an angle (v) which is similarly between 85° and 155°, and most preferably 111°.

The two flattened regions 85a, 85b are substantially perpendicular to each other. The first blade member defines a plane that is coplanar with, or parallel to, a plane defined by the longitudinal axis of the handle. The second blade defines a plane that, in one dimension, is oblique to the plane defined by the longitudinal axis of the handle, but in another dimension, perpendicular to the plane defined by the longitudinal axis. As such, blade member 72 is configured for substantially transverse movement within the mouth of a patient, and the blade member 74 is used for substantially longitudinal movement within the mouth of a patient. Rotation of the handle about its longitudinal axis alternatively and sequentially places the successive first blade or second blade in the operating position, and ready for use. Advantageously, the single instrument provides the dental practitioner with a number of different tools in a single instrument. For example, to utilize either of the plugger elements, the dental practitioner needs only to slightly rotate the tool about the longitudinal axis. Yet, the two pluggers are arcuately spaced apart from each other such that they do not interfere with each other. Furthermore, the two blades are positioned such that the practitioner can easily rotate the tool 180° so as to selectively switch between the first blade member and the second blade member. The first blade member is suitable for substantially transverse movement within the mouth of the patient. The second blade member is then suitable for substantially longitudinal movement within the mouth. Thus, the dental practitioner can rotate the tool about the longitudinal axis of the handle and easily switch without significant translation of the user's hand within the patient's mouth.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A dental instrument comprising:
a handle member having a first end and a second end and a longitudinal axis; and
a tool assembly extending from the first end of the handle member, the tool assembly comprising:
a tool arm having a proximal end extending from the first end of the handle and a distal end spaced therefrom;
a first blade member extending away from the distal end of the tool arm, the first blade member having a first flattened region; and
a second blade member extending away from the distal end of the tool arm, the second blade member having a second flattened region,
wherein the first and second flattened regions are substantially perpendicular to each other in one dimension, wherein the first blade member is configured for substantially transverse movement within a mouth of a patient and wherein the second blade member is configured for substantially longitudinal movement within a mouth of a patient, and wherein rotation of the handle member about the longitudinal axis thereof alternatively places one of the first and second blade member in an operative position.

2. The dental instrument of claim 1 wherein the first flattened region is substantially parallel to a plane defined by the longitudinal axis of the handle.

3. The dental instrument of claim 2 wherein the first flattened region and the second flattened region are angled relative to each other at an angle between 85° and 125°.

4. The dental instrument of claim 1 wherein the second end of the handle member includes a pair of plugger elements.

5. The dental instrument of claim 4 wherein the second end of the handle member includes at least one of a burnisher and a carver.

6. A method of utilizing a dental instrument comprising the steps of:
providing a dental instrument comprising:
a handle member having a first end and a second end and a longitudinal axis;
a tool assembly extending from the first end of the handle member, the tool assembly comprising:
a tool arm having a proximal end extending from the first end of the handle and a distal end spaced therefrom;
a first blade member extending away from the distal end of the tool arm, the first blade member having a first flattened region; and
a second blade member extending away from the distal end of the tool arm, the second blade member having a second flattened region,
utilizing the first blade member;
rotating the handle member along the longitudinal axis a predetermined angular distance; and
utilizing the second blade member.

7. The method of claim 6 wherein the step of utilizing the first blade member further comprises the step of substantially transversely moving the first blade member within the mouth of a patient and wherein the step of utilizing the second blade member further comprises the step of substantially longitudinally moving the second blade member within the mouth of a patient.

8. The method of claim 6 further wherein the dental instrument further comprises a second end having a plurality of plugger members, the method further comprising the step of rotating the tool so as to place the second end in an operative position within the mouth of the patient.
